(19) United States
(12) Patent Application Publication
(10) Pub. No.: US 2025/0007320 A1
(43) Pub. Date: Jan. 2, 2025

(54) POWER SUPPLY CIRCUIT AND ASSOCIATED CONTROL CIRCUIT WITH ADAPTIVE CHARGING PERIOD AND CONTROL METHOD

(71) Applicant: Chengdu Monolithic Power Systems Co., Ltd., Chengdu (CN)

(72) Inventors: Junlin Qian, Chengdu (CN); Yuedong Chen, Chengdu (CN)

(21) Appl. No.: 18/755,984

(22) Filed: Jun. 27, 2024

(30) Foreign Application Priority Data
Jun. 27, 2023 (CN) 202310771160.5

(51) Int. Cl. H02J 7/04; H02J 7/00; H02M 3/335

(52) U.S. Cl. CPC H02J 7/04; H02M 3/33523; H02J 7/00712; H02J 2207/20; H02J 2207/50

(57) ABSTRACT

A control circuit for controlling a power supply voltage is provided. The control circuit includes a charging control circuit and a charging current source. The charging control circuit provides a charging control signal based on an input voltage and the power supply voltage. The charging current source receives the input voltage and provides a charging current to a power supply capacitor for generating the power supply voltage based on the charging control signal. In a charging window, the charging control signal controls the charging current source to start providing the charging current for charging the power supply capacitor after a first time-interval from a start point of the charging window. The charging control signal controls the charging current source to stop providing the charging current when the power supply voltage increases to a charging stop reference voltage. A continuous time duration of providing the charging current is a charging period.

### CROSS-REFERENCE TO RELATED APPLICATIONS

This application claims priority to and the benefit of Chinese Patent Application No. 202310771160.5, filed on Jun. 27, 2023, which is incorporated herein by reference in its entirety.

### TECHNICAL FIELD

The present invention relates generally to electronic circuits, and more particularly but not exclusively to a control circuit used in a power supply circuit with an adaptive charging period and associated control methods.

### BACKGROUND OF THE INVENTION

With the increase of smartphone's functions, fast charging technology is born to meet high power consumption requirements. FIG. 1 schematically shows a conventional voltage converting circuit 10 used in a fast-charging power supply. As shown in FIG. 1, an AC voltage Vac is rectified by a bridge rectifier 101 and then filtered by an input capacitor Cbus (not shown) to obtain a DC voltage Vbus. The DC voltage Vbus is provided to a transformer Tr of the voltage converting circuit 10. The duty cycle of a primary side switch M1 coupled to the transformer Tr is controlled by a voltage converting control circuit 102 to control the transferred energy between the primary side and the secondary side of the transformer Tr, thereby realizing the regulation of an output voltage Vout. The voltage converting control circuit 102 is powered by an auxiliary winding Lt. There is a proportional relationship between a power supply voltage Vcc provided by the auxiliary winding Lt and the output voltage Vout. The proportional coefficient is determined by the turns ratio of the auxiliary winding Lt to a secondary winding Ls, i.e., Vcc: Vout=N (Lt): N (Ls), wherein N represents the number of winding turns. It should be appreciated that, the power supply voltage Vcc should be maintained above a lower limit (usually 10V) to ensure the normal operation of the voltage converting control circuit 102. When the output voltage Vout is 3.3V, the turns ratio of the auxiliary winding Lt to the secondary winding Ls should be at least 3:1. However, if the turns ratio of the auxiliary winding Lt to the secondary winding Ls is 3:1, the power supply voltage Vcc is 60V when the output voltage Vout is 20V. In this case, high voltage devices are required in the voltage converting control circuit 102 and more power loss is produced.

### SUMMARY OF THE INVENTION

According to an embodiment of the present invention, a control circuit for controlling a power supply voltage is provided. The control circuit includes a charging control circuit and a charging current source. The control circuit provides a charging control signal based on an input voltage and the power supply voltage. The charging current source receives the input voltage and provides a charging current to a power supply capacitor for generating the power supply voltage based on the charging control signal. In a charging window, the charging control signal controls the charging current source to start providing the charging current for charging the power supply capacitor after a first time-interval from a start point of the charging window. The charging control signal controls the charging current source to stop providing the charging current when the power supply voltage increases to a charging stop reference voltage. A continuous time duration of providing the charging current is a charging period.

According to another embodiment of the present invention, a power supply circuit for providing a power supply voltage is provided. The power supply circuit includes a power supply capacitor having a charging terminal and a control circuit. The control circuit is coupled to the charging terminal of the power supply capacitor and controls the power supply voltage. The control circuit includes a charging control circuit and a charging current source. The charging control circuit provides a charging control signal based on an input voltage and the power supply voltage. The charging current source receives the input voltage and provides a charging current to the power supply capacitor for generating the power supply voltage based on the charging control signal. In a charging window, the charging control signal controls the charging current source to start providing the charging current for charging the power supply capacitor after a first time-interval from a start point of the charging window. The charging control signal controls the charging current source to stop providing the charging current when the power supply voltage increases to a charging stop reference voltage. A continuous time duration of providing the charging current is a charging period.

According to yet another embodiment of the present invention, a method for controlling a power supply voltage is provided. The method has the following steps. In a charging window, a charging current source is controlled to start providing a charging current for charging a power supply capacitor after a first time-interval from a start point of the charging window. The charging current source is controlled to stop providing the charging current when the power supply voltage increases to a charging stop reference voltage. A continuous time duration of providing the charging current is a charging period.

### BRIEF DESCRIPTION OF THE DRAWINGS

The present invention can be further appreciated with reference to the following detailed description and the appended drawings.

FIG. 1 schematically shows a conventional voltage converting circuit 10 used in a fast-charging power supply.

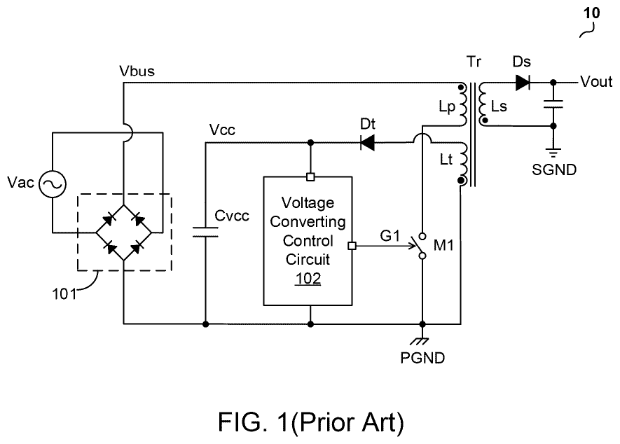

FIG. 2 schematically shows a voltage converting circuit 20 in accordance with an embodiment of the present invention.

FIG. 3 schematically shows a flowchart of a working method 30 of a charging control circuit 23 in accordance with an embodiment of the present invention.

FIG. 4 schematically shows working waveforms of the charging control circuit 23 in accordance with an embodiment of the present invention.

FIG. 5 schematically shows a voltage converting circuit 50 in accordance with an embodiment of the present invention.

FIG. 6 schematically shows a voltage converting circuit 60 in accordance with an embodiment of the present invention.

FIG. 7 schematically shows a voltage converting circuit 70 in accordance with an embodiment of the present invention.

FIG. 8 schematically shows a flowchart of a method 80 for controlling a power supply voltage in accordance with an embodiment of the present invention.

The use of the same reference label in different drawings indicates the same or like components.

### DETAILED DESCRIPTION OF THE INVENTION

Various embodiments of the present invention will be described in detail below, and it should be noted that the embodiments described here are only for illustration. However, the present invention is not limited thereto. In the following description, numerous specific details, such as example circuits and example values for these circuit components, and methods are illustrated in order to provide a thorough understanding of the present invention. It will be apparent for persons having ordinary skill in the art that the present invention can be practiced without one or more specific details, or with other methods, components, materials. In other instances, well-known circuits, materials or methods are not shown or described in detail in order to avoid obscuring the present invention.

Throughout this description, the phrases “in one embodiment”, “in an embodiment”, “in some embodiments”, “in an example”, “in some examples”, “in one implementation”, and “in some implementations” as used to include both combinations and sub-combinations of various features described herein as well as variations and modifications thereof. These phrases used herein does not necessarily refer to the same embodiment, although it may. Additionally, persons having ordinary skill in the art will be appreciated that the drawings provided herein are for illustrative purposes and are not necessarily drawn to scale. The similar elements are provided with similar reference numerals. As used herein, the term “and/or” includes any combinations of one or more of the listed items.

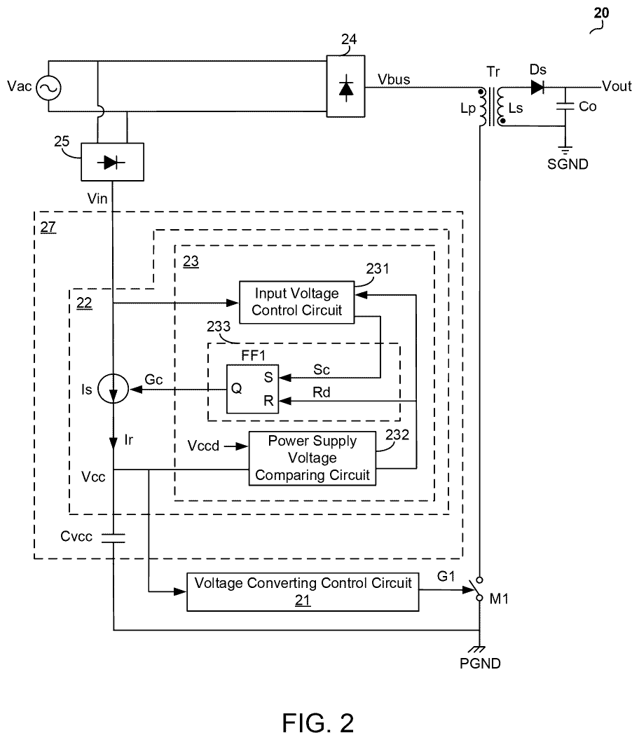

FIG. 2 schematically shows a voltage converting circuit 20 in accordance with an embodiment of the present invention. The voltage converting circuit 20 includes rectifying circuits 24 and 25, a transformer Tr, a primary switch M1, a secondary switch Ds, a voltage converting control circuit 21 and a power supply circuit 27. The rectifying circuit 24 rectifies an AC voltage Vac from an AC power supply and provides a DC voltage Vbus. The DC voltage Vbus is provided to the transformer Tr. The transformer Tr has a primary winding Lp and a secondary winding Ls. The primary switch M1 is coupled to the primary winding Lp. The secondary switch Ds is coupled to the secondary winding Ls. The voltage converting control circuit 21 provides a primary control signal G1 to a control terminal of the primary switch M1, to control the primary switch M1. To be specific, when the primary switch M1 is turned on, the secondary switch Ds is turned off, a current flowing through the primary winding Lp increases, the primary winding Lp stores energy. When the primary switch M1 is turned off, the secondary switch Ds is turned on, the energy stored in the primary winding Lp is transferred to the secondary winding Ls.

The rectifying circuit 25 rectifies the AC voltage Vac from the AC power supply and provides an input voltage Vin having a half-sine wave. The power supply circuit 27 receives the input voltage Vin and provides a power supply voltage Vcc to power the voltage converting control circuit 21.

In some embodiments, the rectifying circuit 24 includes a first bridge rectifier and a filter capacitor, the rectifying circuit 25 includes a second bridge rectifier.

As shown in FIG. 2, the power supply circuit 27 includes a power supply capacitor Cvcc and a power supply control circuit 22. The power supply control circuit 22 includes a charging current source Is and a charging control circuit 23. The power supply capacitor Cvcc has a charging terminal coupled to the charging current source Is and a ground terminal coupled to a primary reference ground PGND. The charging current source Is receives the input voltage Vin and provides a charging current Ir to the power supply capacitor Cvcc. The charging control circuit 23 provides a charging control signal Gc to control the charging current source Is. Under the control of the charging control signal Gc, the charging current source Is provides a charging current Is to charge the power supply capacitor Cvcc to generate the power supply voltage Vcc. It should be appreciated that, both of the charging current source Is and the charging control circuit 23 could be integrated with the voltage converting control circuit 21 in an integrated circuit, and the power supply voltage Vcc could be used for powering the integrated circuit.

In the embodiment of FIG. 2, the charging control circuit 23 includes an input voltage control circuit 231, a power supply voltage comparing circuit 232, and a charging control logic circuit 233. The power supply voltage comparing circuit 232 receives the power supply voltage Vcc and a charging stop reference voltage Vccd, and provides a charging stop signal Rd. The input voltage control circuit 231 receives the input voltage Vin and the charging stop signal Rd, and provides a charging set signal Sc. The charging control logic circuit 233 receives the charging set signal Sc and the charging stop signal Rd, and provides the charging control signal Gc to control the charging current source Is. In the embodiment shown in FIG. 2, the charging control logic circuit 233 includes a RS flip-flop FF1. The RS flip-flop FF1 has a set terminal, a reset terminal and an output terminal. The set terminal of the RS flip-flop FF1 is configured to receive the charging set signal Sc. The reset terminal of the RS flip-flop FF1 is configured to receive the charging stop signal Rd. The output terminal of the RS flip-flop FF1 is configured to provide the charging control signal Gc.

In a charging window Cw, the charging control signal Gc controls the charging current source Is to start providing the charging current Ir for charging the power supply capacitor Cvcc after a first time-interval T1 from a start point of the charging window Cw. The charging control signal Gc controls the charging current source Is to stop providing the charging current Ir when the power supply voltage Vcc increases to the charging stop reference voltage Vccd. A continuous time duration of providing the charging current Ir is a charging period. In other words, the charging period starts at the time when the charging current source Is starts providing the charging current Ir and ends at the time when the charging current source Is stops providing the charging current Ir.

The charging window Cw is symmetric with respect to a minimum value of the input voltage Vin (e.g., 0V). In some embodiments, the charging window Cw starts in response to the input voltage Vin decreasing to a charging window threshold voltage Vr and ends in response to the input voltage Vin increasing to the charging window threshold voltage Vr.

The input voltage control circuit 231 could be realized by a digital circuit. In other words, functions and working process of the input voltage control circuit 231 could be described by a digital language to generate the digital circuit automatically.

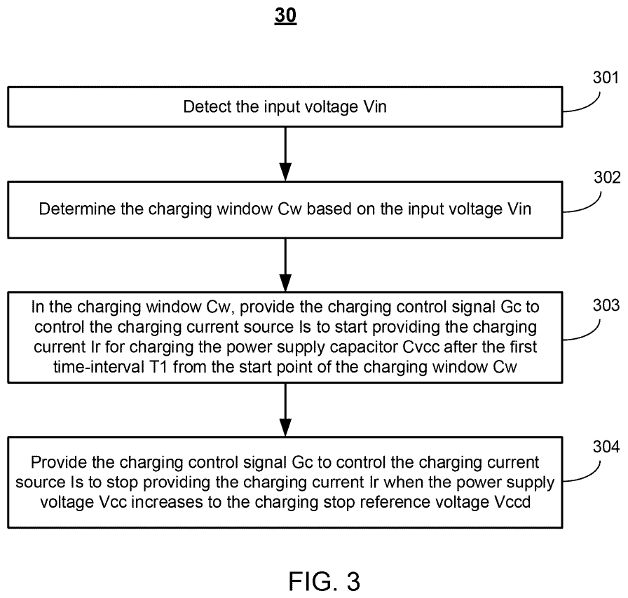

FIG. 3 schematically shows a flowchart of a working method 30 of the charging control circuit 23 in accordance with an embodiment of the present invention. As shown in FIG. 3, the working method 30 includes steps 301-304.

In step 301, the input voltage Vin is detected. In step 302, the charging window Cw is determined based on the input voltag Vin. In step 303, in the charging window Cw, the charging control signal Gc is provided to control the charging current source Is to start providing the charging current Ir for charging the power supply capactior Cvcc after the first time-interval T1 from the start point of the charging window Cw. In step 304, the charging control signal Gc is provided to control the charging current source Is to stop providing the charging current Ir when the power supply voltage Vcc increases to the charging stop reference voltage Vccd.

The steps of the aforementioned working method 30 could be performed in different orders.

The input voltage Vin is a rectified half-sine wave, which is obtained by rectifying the AC voltage Vac from the AC power supply. The period of the input voltage Vin is half of the period of the AC voltage Vac, and the frequency of the input voltage Vin is twice of the frequency of the AC voltage Vac. A peak value of the input voltage Vin is substantially fixed when the AC voltage Vac is determined. It should be understood that “substantially” is a term of art, and is meant to convey the principle that relationship such simultaneity or perfect synchronization cannot be met with exactness, but only within the tolerances of the technology available to a practitioner of the art under discussion. In step 302, a width of the charging window Cw is determined by the peak value of the input voltage Vin. In one embodiment, when the peak value of the input voltage Vin is 100V, the charging window threshold voltage Vr is 10V. The width of the charging window Cw is a time duration that starts from a time when the input voltage Vin decreases to 10V and ends at a time when the input voltage Vin increases to 10V subsequently. High charging window threshold voltage Vr may result in low circuit efficiency, low charging window threshold voltage Vr may result in an inability to provide sufficient power supply voltage Vcc timely. Persons having ordinary skill in the art could set the charging window threshold voltage Vr according to the specifications and requirements of practical applications. For instance, when the peak value of the input voltage Vin is 100V, the charging window threshold voltage Vr could be set to 15V or 20V.

In some embodiments, the charging window threshold voltage Vr is a constant value (e.g., 10V). In this case, when the frequency of the input voltage Vin is fixed, the higher the peak value of the input voltage Vin is, the narrower the charging window Cw is. In contrast, the lower the peak value of the input voltage Vin is, the wider the charging window Cw is.

In some embodiments, there is a proportional relationship between the charging window threshold voltage Vr and the peak value of the input voltage Vin. In this case, when the input voltage Vin is the rectified half-sine wave, the width of the charging window Cw is related to the frequency of the input voltage Vin rather than the peak value of the input voltage Vin. In one embodiment, when Vr=0.7Vin_pk, the width of the charging window Cw is about Tin/2, wherein the Vin_pk represents the peak value of the input voltage Vin, Tin represents the period of the input voltage Vin having the half-sine wave.

In some embodiments, the charging window threshold voltage Vr could be adjusted based on the peak value of the input voltage Vin. For example, when the peak value of the input voltage Vin is higher than a threshold voltage (e.g., 100V), the charging window threshold voltage Vr is a constant value (e.g., 50V). When the peak value of the input voltage Vin is lower than the threshold voltage (e.g., 100V), the charging window threshold voltage Vr is proportional to the peak value of the input voltage Vin (e.g., Vr=0.5Vin_pk).

In one embodiment, when the frequency of the input voltage Vin is fixed, the higher the input voltage Vin is, the higher the charging window threshold voltage Vr is, and the wider the charging window Cw is. On the contrary, the lower the input voltage Vin is, the lower the charging window threshold voltage Vr is, and the narrower the charging window Cw is.

In the embodiments of the present invention, the charging window Cw further includes a second time-interval T2. The second time-interval T2 starts in response to stopping providing the charging current Ir and ends at an end point of the charging window Cw. That is to say, in some embodiments, the time duration of the charging window Cw is a sum of the first time-interval T1, the charging period and the second time-interval T2.

In one embodiment, the first time-interval T1 in a subsequent charging window Cw is determined based on the first time-interval T1 and the second time-interval T2 in a current charging window Cw.

The power supply voltage comparing circuit 232 may be a comparator. In one embodiment, when the power supply voltage Vcc increases to the charging stop reference voltage Vccd, the charging stop signal Rd is enabled. It should be appreciated that, other conventional circuits that could generate signals to indicate that the power supply voltage Vcc increases to the charging stop reference voltage Vccd could also be utilized as the power supply voltage comparing circuit.

The state of the signal may be represented by different voltage levels. For example, a high level is indicative of an enabled state of the signal, and a low level is indicative of a disabled state of the signal. In another example, the high level is indicative of the disabled state of the signal, and the low level is indicative of the enabled state of the signal. In the embodiments of the present invention, other features of the signal could also be utilized to indicate the state of the signal, for example, a rise edge and a fall edge of the signal. It should also be noted that, the enabled states (or disabled state) of different signals do not need to be consistent and could be different from each other.

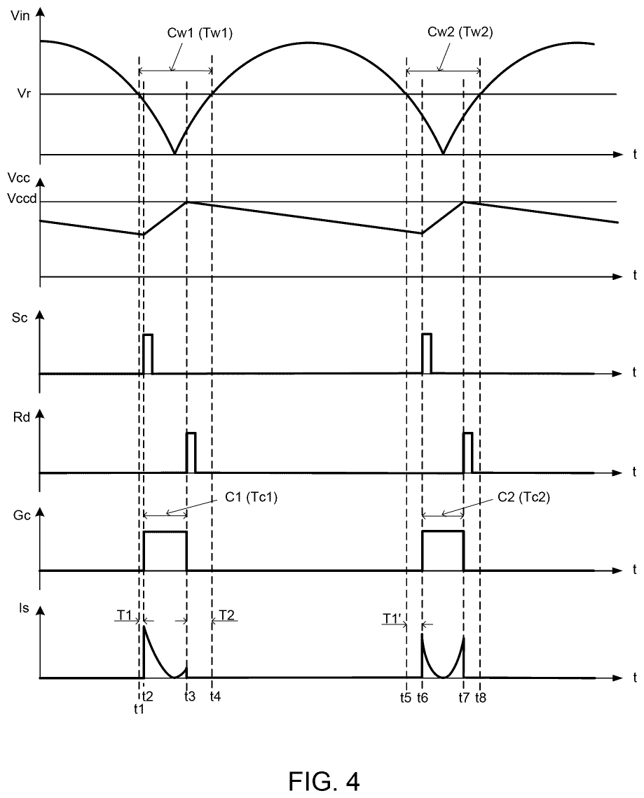

FIG. 4 schematically shows working waveforms of the charging control circuit 23 in accordance with an embodiment of the present invention. The working principle of the charging control circuit 23 is described below with reference to FIGS. 2-4.

As shown in FIG. 4, at time t1, the input voltage Vin decreases to the charging window threshold voltage Vr, a charging window Cw1 (from t1-t4) starts. After the first time-interval T1, at time t2, the input voltage control circuit 231 provides the charging set signal Sc to set the RS flip-flop FF1. The RS flip-flop FF1 provides the charging control signal Gc to control the charging current source Is to provide the charging current Ir. A charging period C1 (from t2-t3) starts. The power supply capacitor Cvcc is charged, the power supply voltage Vcc increases. At time t3, the power supply voltage Vcc increases to the charging stop reference voltage Vccd, the power supply voltage comparing circuit 232 provides the charging stop signal Rd to reset the RS flip-flop FF1. The RS flip-flop FF1 provides the charging control signal Gc to control the charging current source Is to stop providing the charging current Ir. The charging period C1 ends. The input voltage control circuit 231 starts timing at the time when the charging period C1 ends. At time t4, the input voltage Vin increases to the charging window threshold voltage Vr, the charging window Cw1 ends and the timing is finished. The timing duration is recorded as the second time-interval T2. Based on the first time-interval T1 and the second time-interval T2 in the charging window Cw1, the first time-interval T1′ in a subsequent charging window Cw2 (from t5-t8) is adjusted to (T1+T2)/2. That is to say, in the charging window Cw2, the charging control signal Gc controls the charging current source Is to starts providing the charging current Ir after the first time-interval T1′ from time t5 (i.e., a start point of the charging window Cw2). As shown in FIG. 4, at time t6, a charging period C2 (from t6-t7) in the charging window Cw2 starts.

In summary, the first time-interval T1 in the subsequent charging window Cw is adjusted based on the first time-interval T1 and the second time-interval T2 in the current charging window Cw. When the variation of a load supplied by the power supply voltage Vcc is not too large, through adjusting the first time-interval T1, the charging period is adjusted to be substantially symmetric with respect to the minimum value of the input voltage Vin. Thereby, the efficiency of charging the power supply capacitor Cvcc to generate the power supply voltage Vcc by the input voltage Vin is improved. As shown in FIG. 4, for example, the charging period C2 (from t6-t7) in the charging window Cw2 (from t5-t8) is adjusted to be substantially symmetric with respect to the minimum value of the input voltage Vin.

In some embodiments of the present invention, the first time-interval T1 in the subsequent charging window Cw is obtained by averaging the first time-interval T1 and the second time-interval T1 in the current charging window Cw. The timing of the second time-interval T2 starts in response to a charging stop time (i.e., the time point when the charging current source Is stops providing the charging current Ir) and ends in response to the end point of the charging window Cw. In the embodiment of FIG. 2, the charging stop signal Rd is provided to the input voltage control circuit 231 for indicating the charging stop time. Persons having ordinary skill in the art should be appreciated that, other signals (e.g., the charging control signal Gc) that are capable of indicating the charging stop time could also be utilized to control the timing of the second time-interval T2.

In some embodiments of the present invention, the first time-interval T1 in the subsequent charging window could be adjusted based on the width of the current charging window Cw and a width of the charging period in the current charging window Cw. For instance, in FIG. 4, T1′=(Tw1-Tc1)/2, wherein Tw1 represents the width of the charging window Cw1, Tc1 represents the width of the charging period C1.

In some embodiment, the first time-interval T1 and the second time-interval T2 could be represented by duration values. In other embodiments, the first time-interval T1 and the second time-interval T2 could be represented by counted numbers. The counted numbers are obtained by counting the first time-interval T1 and the second time-interval T2 at a fixed frequency. For example, in the current charging window Cw, the first time-interval T1 is represented by counted number 3, and the second time-interval T2 is represented by counted number 11, so the counted number of the first time-interval T1 in the subsequent charging window Cw is 7. After the start point of the subsequent charging window Cw, the subsequent charging period starts when the counted number reaches 7.

In the embodiments of the present invention, the charging period is inside the charging window Cw. In the embodiment of FIG. 4, the charging period ends before the charging window Cw ends. In other embodiments, the charging period and the charging window Cw end at the same time. For example, when the charging window Cw ends but the power supply voltage Vcc does not increase to the charging stop reference voltage Vccd, the charging current source Is is controlled to stop providing the charging current Ir to end the charging period.

In the embodiments of FIG. 2 and FIG. 4, the power supply voltage comparing circuit 232 includes a comparator and a pulse circuit. The comparator compares the power supply voltage Vcc with the charging stop reference voltage Vccd, and provides a comparing signal based on the comparison result. The pulse circuit receives the comparing signal and provides a pulse signal based on the comparing signal. The pulse signal provides a pulse when the comparing signal indicates that the power supply voltage Vcc increases to the charging stop reference voltage Vccd. In some embodiments, the power supply voltage comparing circuit 232 includes a comparator. The comparator compares the power supply voltage Vcc with the charging stop reference voltage Vccd and provides the comparing signal to indicate the comparison result. The comparing signal is used as the charging stop signal Rd directly for resetting the RS flip-flop FF1.

In some applications, because of the impact of the post-stage circuit, for example, there is a high resistance in a connection node between the voltage converting control circuit 21 and the input voltage Vin. The waveform shape of the input voltage Vin may be partially consistent with the rectified half-sine wave as shown in FIG. 4. For instance, the waveform shape of the input voltage Vin shows a filtered waveform shape without any voltage valley. In that case, the input voltage Vin is required to be regulated to show the rectified half-sine wave shown in FIG. 4, to ensure the normal operation of the power supply control circuit 22.

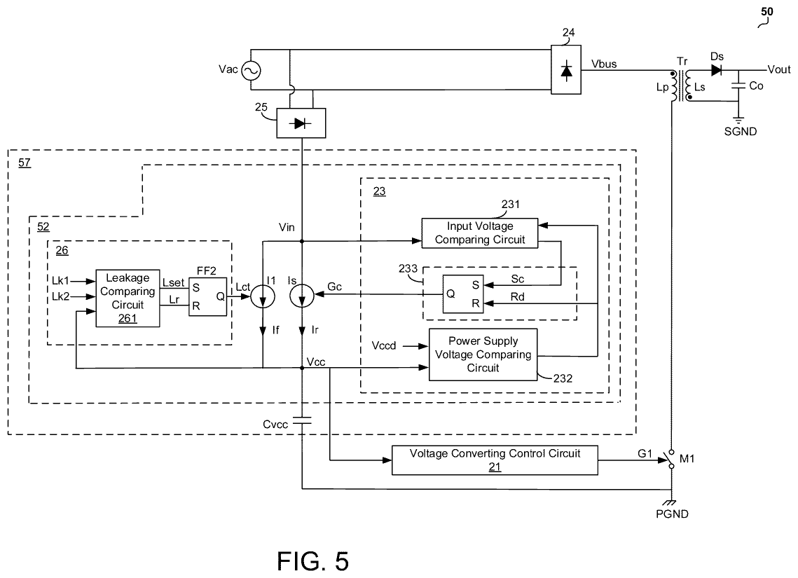

FIG. 5 schematically shows a voltage converting circuit 50 in accordance with an embodiment of the present invention. In the embodiment of FIG. 5, the voltage converting circuit 50 includes a power supply circuit 57. The power supply circuit 57 includes the power supply capacitor Cvcc and a power supply control circuit 52. The power supply control circuit 52 includes the charging current source Is, the charging control circuit 23, a leakage current source 11 and a leakage control circuit 26. The leakage control circuit 26 receives the power supply voltage Vcc and compares the power supply voltage Vcc with a leakage charging reference voltage Lk1 and a leakage stop reference voltage Lk2. The leakage control circuit 26 provides a leakage control signal Lct to control the leakage current source 11 to start providing a leakage current If for charging the power supply capacitor Cvcc when the power supply voltage Vcc decreases to the leakage charging reference voltage Lk1. The leakage control circuit 26 provides the leakage control signal Lct to control the leakage current source 11 to stop providing the leakage current If when the power supply voltage Vcc increases to the leakage stop reference voltage Lk2.

In the embodiment of FIG. 5, the leakage control circuit 26 includes a leakage comparing circuit 261 and a RS flip-flop FF2. The leakage comparing circuit 261 compares the power supply voltage Vcc with the leakage charging reference voltage Lk1 and the leakage stop reference voltage Lk2, and provides a leakage set signal Lset and a leakage reset signal Lr based on the comparison result. The RS flip-flop FF2 has a set terminal, a reset terminal and an output terminal. The set terminal of the RS flip-flop FF2 is configured to receive the leakage set signal Lset. The reset terminal of the RS flip-flop FF2 is configured to receive the leakage reset signal Lr. The output terminal of the RS flip-flop FF2 is configured to provide the leakage control signal Lct. In one embodiment, the leakage charging reference voltage Lk1 is lower than the leakage stop reference voltage Lk2.

In some embodiments, the leakage comparing circuit 261 may be a hysteresis comparator. In other embodiments, the leakage comparing circuit 261 may include two distinct comparators.

In the embodiment of FIG. 5, the input voltage Vin is pulled down by the leakage current source 11 with a small current. The impact of the internal high resistance and the large parasitic capacitance of the voltage converting control circuit 21 on the input voltage Vin through the power supply voltage Vcc is eliminated. Therefore, the input voltage Vin could maintain the rectified half-sine wave and the power supply control circuit 52 could operate normally.

In some embodiments, the normal operation of the power supply control circuit 22 is realized by setting the charging window threshold voltage Vr properly. For example, the charging window threshold voltage Vr is set to be higher than a clamp voltage of the input voltage Vin. Even if the input voltage Vin is clamped thus cannot decrease to its lowest point, the power supply control circuit 22 could still operate normally. Consequently, the leakage current source 11 and the leakage control circuit 26 are not necessary.

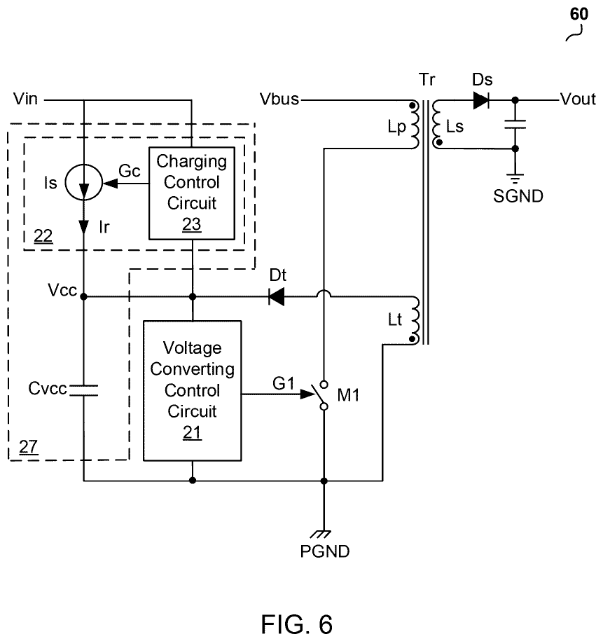

FIG. 6 schematically shows a voltage converting circuit 60 in accordance with an embodiment of the present invention. The voltage converting circuit 60 includes the transformer Tr, the primary switch M1, the secondary switch Ds, the voltage converting control circuit 21 and the power supply circuit 27. The transformer Tr has the primary winding Lp, the secondary winding Ls and an auxiliary winding Lt. The primary switch M1 is coupled to the primary winding Lp. The secondary switch Ds is coupled to the secondary winding Ls. The voltage converting control circuit 21 provides the primary control signal G1 to the control terminal of the primary switch M1, to control the primary switch M1. The voltage converting control circuit 21 is powered by the power supply voltage Vcc. The power supply circuit 27 includes the power supply capacitor Cvcc and the power supply control circuit 22. The power supply control circuit 22 includes the charging control circuit 23 and the charging current source Is. The charging current source Is receives the input voltage Vin and provides the charging current Ir to the power supply capacitor Cvcc for generating the power supply voltage Vcc. The charging control circuit 23 receives the input voltage Vin and the power supply voltage Vcc, and provides the charging control signal Gc to control the charging current source Is to provide the charging current Ir for charging the power supply capacitor Cvcc.

In the embodiment of FIG. 6, the auxiliary winding Lt of the transformer Tr is coupled to the charging terminal of the power supply capacitor Cvcc through a diode Dt. When a voltage provided by the auxiliary winding Lt is higher than a maximum voltage of the power supply capacitor Cvcc reached by being charged by the input voltage Vin (i.e., the charging stop reference voltage Vccd), the power supply capacitor Cvcc is charged by the auxiliary winding Lt. Persons skilled in the art could properly set the charging stop reference voltage Vccd and the turns ratio of the auxiliary winding Lt to the secondary winding Ls according to the specifications and requirements of applications. Thereby, in order to maintain the power supply voltage Vcc, when the output voltage Vout is relatively low, the charging control circuit 23 controls the charging current source Is to charge the power supply capacitor Cvcc; and when the output voltage Vout is relatively high, the power supply capacitor Cvcc is charged by the auxiliary winding Lt.

When the output voltage Vout is low, the power supply capacitor Cvcc is charged by the charging current source Is instead of the auxiliary winding Lt, thus high turns ratio of the auxiliary winding Lt to the secondary winding Ls is not necessary. It means the turns ratio of the auxiliary winding Lt to the secondary winding Ls could be 1:1 or 1:2, or even lower. When the turns ratio of the auxiliary winding Lt to the secondary winding Ls is 1:2, even if the output voltage Vout is 20V, the power supply voltage Vcc is 10V. That is to say, when the turns ratio of the auxiliary winding Lt to the secondary winding Ls is low, even if the output voltage Vout is relatively high, the voltage provided by the auxiliary winding Lt is low, thus the voltage converting control circuit 21 does not need to withstand the high voltage. As a result, high voltage devices are not required, and the power dissipation caused by the high voltage is also reduced.

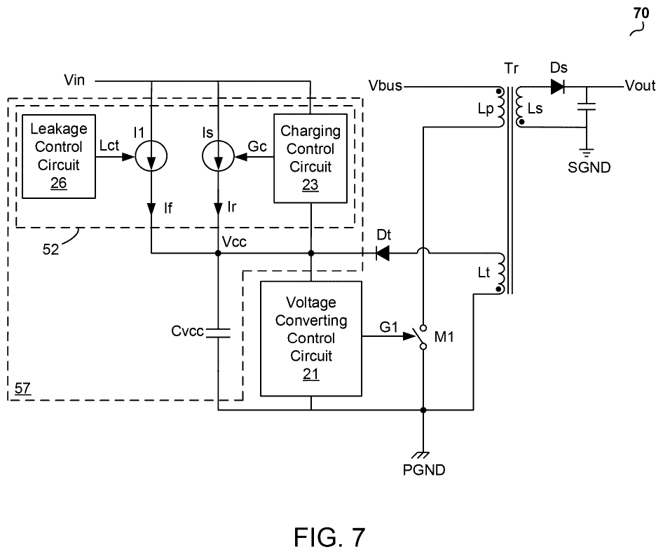

FIG. 7 schematically shows a voltage converting circuit 70 in accordance with an embodiment of the present invention. Compared with the embodiment of FIG. 6, the voltage converting circuit 70 shown in FIG. 7 includes the power supply circuit 57. The power supply circuit 57 includes the power supply control circuit 52. As illustrated above, the leakage current source 11 starts providing the leakage current If for charging the power supply capacitor Cvcc when the power supply voltage Vcc decreases to the leakage charging reference voltage Lk1; and the leakage current source 11 stops providing the leakage current If when the power supply voltage Vcc increases to the leakage stop reference voltage Lk2.

It should be appreciated that, the logic circuits in the embodiments of the present invention, for example, the charging control logic circuit 233 and flip-flops FF1 and FF2 just for illustration purposes. The logic circuits could be changed along with the change of the polarity of the input/output signal of the logic circuits.

In some embodiments, some or all of the charging control circuit 23, the leakage control circuit 26, the charging current source Is, the leakage current source 11 are integrated with the voltage converting control circuit 21 in an integrated circuit, and the power supply voltage Vcc could also be used for powering the integrated circuit. In one embodiment, the charging current source Is includes a switch. A control terminal of the switch is configured to receive the charging control signal Gc.

The voltage converting circuit 20, 50, 60 and 70 have a FLYBACK topology in the embodiments of the present invention. It should be appreciated that, the voltage converting circuit 20, 50, 60 and 70 could have other topologies (e.g., Buck topology and Boost topology). The power supply control circuit in the embodiments of the present invention could also be utilized in the other voltage converting circuit having different topologies.

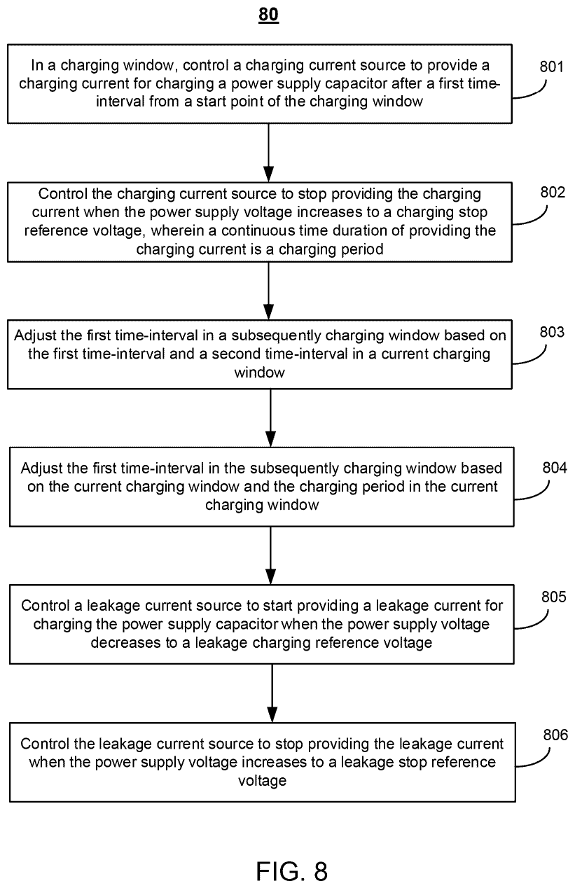

FIG. 8 schematically shows a flowchart of a method 80 for controlling a power supply voltage in accordance with an embodiment of the present invention. The method 80 may be used to control a charging current source to charge a power supply capacitor for generating a power supply voltage to power an integrated circuit. In some embodiments, the integrated circuit may include the voltage converting control circuit 21 as shown in FIG. 2 and FIGS. 5-7. The charging current source receives an input voltage and provides a charging current to the power supply capacitor for generating the power supply voltage. The input voltage is received from an AC power supply through a rectifying circuit. The AC power supply provides an AC voltage having a sine wave, thus the waveform shape of the input voltage shows a rectified half-sine wave. The method 80 includes steps 801 and 802.

In step 801, in a charging window, the charging current source is controlled to start providing the charging current for charging the power supply capacitor after a first time-interval from a start point of the charging window. In step 802, the charging current source is controlled to stop providing the charging current when the power supply voltage increases to a charging stop reference voltage. A continuous time duration of providing the charging current is a charging period. The charging period is adjusted to be substantially symmetric with respect to a minimum value of the input voltage.

In one embodiment, the charging window further comprises a second time-interval, the second time-interval starts in response to stopping providing the charging current and ends at an end point of the charging window, and the method 80 further includes step 803. In step 803, the first time-interval in a subsequent charging window is adjusted based on the first time-interval and the second time-interval in a current charging window.

In one embodiment, the method 80 further includes step 804. In step 804, the first time-interval in the subsequent charging window is adjusted based on the current charging window and the charging period in the current charging window.

In one embodiment, a leakage current source is coupled between the input voltage and the power supply capacitor, and the method 80 further includes steps 805-806.

In step 805, the leakage current source is controlled to start providing a leakage current for charging the power supply capacitor when the power supply voltage decreases to a leakage charging reference voltage. In step 806, the leakage current source is controlled to stop providing the leakage current when the power supply voltage increases to a leakage stop reference voltage.

The method 80 illustrated above could be performed in different orders.

In one embodiment, the leakage stop reference voltage is higher than the leakage charging reference voltage.

In one embodiment, the leakage stop reference voltage is equal to the charging stop reference voltage.

In one embodiment, a width of the charging window is adjusted based on a peak value of the input voltage.

In one embodiment, the charging window starts in response to the input voltage decreasing to a charging window threshold voltage and ends in response to the input voltage increasing to the charging window threshold voltage.

In some embodiments, the charging window threshold voltage is a constant value. In this case, when the frequency of the input voltage is fixed, the higher the peak value of the input voltage is, the narrower the charging window is. On the contrary, the lower the peak value of the input voltage is, the wider the charging window is.

In some embodiments, there is a proportional relationship between the charging window threshold voltage and the peak value of the input voltage. In this case, if the input voltage is the rectified half-sine wave, the width of the charging window is related to the frequency of the input voltage rather than the peak value of the input voltage. In one embodiment, the charging window threshold voltage is 0.7xVin_pk, the width of the charging window is about Tin/2, wherein the Vin_pk represents the peak value of the input voltage, Tin represents the period of the input voltage having the half-sine wave.

In some embodiments, the charging window threshold voltage could be adjusted based on the peak value of the input voltage. For example, when the peak value of the input voltage Vin is higher than a threshold voltage, the charging window threshold voltage is a constant value. When the peak value of the input voltage is lower than the threshold voltage, the charging window threshold voltage is proportional to the peak value of the input voltage. For example, the charging window threshold voltage is 0.5×Vin_pk, wherein Vin_pk represents the peak value of the input voltage.

It should be understood, the circuit and the workflow given in the present invention are just for schematic illustration. Any circuit can realize the function and operation of the present invention does not depart from the spirit and the scope of the invention.

While specific embodiments of the present invention have been provided, it is to be understood that these embodiments are for illustration purposes and not limiting. Since the invention can be practiced in various forms without distracting the spirit or the substance of the invention. It should be appreciated that the above embodiments are not confined to any aforementioned specific detail but should be explanatory broadly within the spirit and scope limited by the appended claims. Thus, all the variations and modification falling into the scope of the claims and their equivalents should be covered by the appended claims.

What is claimed is:

1. A control circuit for controlling a power supply voltage, comprising:
a charging control circuit configured to provide a charging control signal based on an input voltage and the power supply voltage;
a charging current source configured to receive the input voltage and to provide a charging current to a power supply capacitor for generating the power supply voltage based on the charging control signal; and wherein
in a charging window, the charging control signal controls the charging current source to start providing the charging current for charging the power supply capacitor after a first time-interval from a start point of the charging window and to stop providing the charging current when the power supply voltage increases to a charging stop reference voltage, wherein a continuous time duration of providing the charging current is a charging period.

2. The control circuit of claim 1, wherein the charging period is adjusted to be substantially symmetric with respect to a minimum value of the input voltage.

3. The control circuit of claim 1, wherein the charging window starts in response to the input voltage decreasing to a charging window threshold voltage and ends in response to the input voltage increasing to the charging window threshold voltage.

4. The control circuit of claim 1, wherein the charging window further comprises a second time-interval, the second time-interval starts in response to stopping providing the charging current and ends at an end point of the charging window; and wherein:
the first time-interval in a subsequent charging window is adjusted based on the first time-interval and the second time-interval in a current charging window.

5. The control circuit of claim 1, wherein the first time-interval in a subsequent charging window is adjusted based on a current charging window and the charging period in the current charging window.

6. The control circuit of claim 3, wherein the charging window threshold voltage is a constant value.

7. The control circuit of claim 3, the charging window threshold voltage is proportional to a peak value of the input voltage.

8. The control circuit of claim 1, further comprising:
a leakage control circuit configured to provide a leakage control signal based on the power supply voltage, a leakage charging reference voltage and a leakage stop reference voltage;
a leakage current source coupled in parallel with the charging current source, and configured to provide a leakage current to the power supply capacitor based on the leakage control signal; and wherein
the leakage control signal controls the leakage current source to start providing the leakage current for charging the power supply capacitor when the power supply voltage decreases to the leakage charging reference voltage and to stop providing the leakage current when the power supply voltage increases to the leakage stop reference voltage.

9. A power supply circuit for providing a power supply voltage, comprising:
a power supply capacitor having a charging terminal; and
a control circuit coupled to the charging terminal of the power supply capacitor, and configured to control the power supply voltage, comprising:
a charging control circuit configured to provide a charging control signal based on an input voltage and the power supply voltage;
a charging current source configured to receive the input voltage and to provide a charging current to the power supply capacitor for generating the power supply voltage based on the charging control signal; and wherein
in a charging window, the charging control signal controls the charging current source to start providing the charging current for charging the power supply capacitor after a first time-interval from a start point of the charging window and to stop providing the charging current when the power supply voltage increases to a charging stop reference voltage, wherein a continuous time duration of providing the charging current is a charging period.

10. The power supply circuit of claim 9, wherein the charging period is adjusted to be substantially symmetric with respect to a minimum value of the input voltage.

11. The power supply circuit of claim 9, wherein the charging window starts in response to the input voltage decreasing to a charging window threshold voltage and ends in response to the input voltage increasing to the charging window threshold voltage.

12. The power supply circuit of claim 9, wherein the charging window further comprises a second time-interval, the second time-interval starts in response to stopping providing the charging current and ends at an end point of the charging window; and wherein:
the first time-interval in a subsequent charging window is adjusted based on the first time-interval and the second time-interval in a current charging window.

13. The power supply circuit of claim 9, wherein the first time-interval in a subsequent charging window is adjusted based on a current charging window and the charging period in the current charging window.

14. The power supply circuit of claim 11, wherein when a peak value of the input voltage is higher than a threshold voltage, the charging window threshold voltage is a constant value, and when the peak value of the input voltage is lower than the threshold voltage, the charging window threshold voltage is proportional to the peak value of the input voltage.

15. The power supply circuit of claim 9, wherein the charging terminal of the power supply capacitor is coupled to an auxiliary winding of a transformer of a voltage converting circuit through a diode.

16. A method for controlling a power supply voltage, comprising:
in a charging window, controlling a charging current source to start providing a charging current for charging a power supply capacitor after a first time-interval from a start point of the charging window; and
controlling the charging current source to stop providing the charging current when the power supply voltage increases to a charging stop reference voltage, wherein a continuous time duration of providing the charging current is a charging period.

17. The method of claim 16, wherein the charging period is adjusted to be substantially symmetric with respect to a minimum value of an input voltage.

18. The method of claim 16, wherein the charging window starts in response to an input voltage decreasing to a charging window threshold voltage and ends in response to the input voltage increasing to the charging window threshold voltage.

19. The method of claim 16, wherein the charging window further comprises a second time-interval, the second time-interval starts in response to stopping providing the charging current and ends at an end point of the charging window, and the method further comprising:
adjusting the first time-interval in a subsequent charging window based on the first time-interval and the second time-interval in a current charging window.

20. The method of claim 16, further comprising:
adjusting the first time-interval in a subsequent charging window based on a current charging window and the charging period in the current charging window.
